(19) United States
(12) Patent Application Publication
(10) Pub. No.: US 2026/0236207 A1
(43) Pub. Date: Aug. 13, 2026

(54) PRINTING CONTROL APPARATUS, PRINTING CONTROL METHOD, AND PRINTING SYSTEM

(71) Applicant: SEIKO EPSON CORPORATION, Tokyo (JP)

(72) Inventors: Katsuhito KITAHARA, Matsumoto (JP); Takashi SERA, Shiojiri (JP); Kohei YAMAMOTO, Matsumoto (JP); Masayuki KOBAYASHI, Fujimi-machi (JP)

(21) Appl. No.: 19/530,439

(22) Filed: Feb. 5, 2026

(30) Foreign Application Priority Data
Feb. 7, 2025 (JP) 2025-019157

(51) Int. Cl. G06F 3/12

(52) U.S. Cl. CPC G06F 3/1252; G06F 3/1205; G06F 3/1208; G06F 3/1256; G06F 3/1288

(57) ABSTRACT

A printing control apparatus includes: an image acquisition section that causes a terminal device to display a list of images stored in the terminal device and acquires an image selected as a print target from the list; a multi-up layout acquisition section that causes the terminal device to display candidates for a plurality of multi-up layouts and acquires the multi-up layout selected from the candidates; a preview display section that causes the terminal device to display a preview image in which the selected image is arranged according to the multi-up layout; and a printing instruction transmission section that generates print data in which the selected image is arranged according to the multi-up layout and transmits a printing instruction to a printing apparatus, in which at least one of the image acquisition section, the multi-up layout acquisition section, and the preview display section is processed via a chat server.

The present application is based on, and claims priority from JP Application Serial Number 2025-019157, filed February 7, 2025, the disclosure of which is hereby incorporated by reference herein in its entirety.

### BACKGROUND

### 1. Technical Field

The present disclosure relates to a printing control apparatus, a printing control method, and a printing system.

### 2. Related Art

In the related art, for example, as disclosed in JP-A-2021-33425, there is known chat printing in which a file posted in a chat room of a chat application is printed by a designated printing apparatus.

Meanwhile, in the chat printing in the related art, multi-up printing is not available. In addition, in the chat printing, a user cannot easily review a content or the like of an instruction of the user in a process of the instruction of the user to perform multi-up printing.

### SUMMARY

According to an aspect of the present disclosure, there is provided a printing control apparatus including: an image acquisition section that causes a terminal device to display a list of images stored in the terminal device and acquires an image selected as a print target from the list on the terminal device; a multi-up layout acquisition section that causes the terminal device to display candidates for a plurality of multi-up layouts and acquires the multi-up layout selected from the candidates; a preview display section that causes the terminal device to display a preview image in which the selected image is arranged according to the multi-up layout; and a printing instruction transmission section that generates print data in which the selected image is arranged according to the multi-up layout and transmits a printing instruction for the print data to a printing apparatus, in which at least one of the image acquisition section, the multi-up layout acquisition section, and the preview display section is processed via a chat server.

According to another aspect of the present disclosure, there is provided a printing control method in a printing control apparatus, the method including: displaying, via an image acquisition section, a list of images stored in a terminal device on the terminal device and acquiring an image selected as a print target from the list on the terminal device; displaying, via a multi-up layout acquisition section, candidates for a plurality of multi-up layouts on the terminal device and acquiring the multi-up layout selected from the candidates; displaying, via a preview display section, a preview image in which the selected image is arranged according to the multi-up layout on the terminal device; and generating, via a printing instruction transmission section, print data in which the selected image is arranged according to the multi-up layout and transmitting a printing instruction for the print data to a printing apparatus, in which at least one of the image acquisition section, the multi-up layout acquisition section, and the preview display section is processed via a chat server.

According to still another aspect of the present disclosure, there is provided a printing system including: a printing control apparatus; and a printing apparatus, the printing control apparatus configured to include an image acquisition section that causes a terminal device to display a list of images stored in the terminal device and acquires an image selected as a print target from the list on the terminal device, a multi-up layout acquisition section that causes the terminal device to display candidates for a plurality of multi-up layouts and acquires the multi-up layout selected from the candidates, a preview display section that causes the terminal device to display a preview image in which the selected image is arranged according to the multi-up layout, and a printing instruction transmission section that generates print data in which the selected image is arranged according to the multi-up layout and transmits a printing instruction for the print data to the printing apparatus, in which the printing apparatus executes printing based on the print data, and at least one of the image acquisition section, the multi-up layout acquisition section, and the preview display section is processed via a chat server.

### BRIEF DESCRIPTION OF THE DRAWINGS

FIG. 1 is a block diagram of a printing system.

FIG. 2 is a sequence diagram illustrating an example of a printing sequence.

FIG. 3 is a sequence diagram illustrating another example of the printing sequence.

FIG. 4 is a diagram illustrating a display example of a chat room.

FIG. 5 is a diagram illustrating another display example of the chat room.

FIG. 6 is a diagram illustrating a display example when a multi-up layout is selected.

FIG. 7 is a diagram illustrating a display example when a print target image is selected.

FIG. 8 is a diagram illustrating a display example of a preview image.

FIG. 9 is a diagram illustrating another display example when the multi-up layout is selected.

FIG. 10 is a diagram illustrating another display example when the print target image is selected.

FIG. 11 is a diagram illustrating another display example of the preview image.

FIG. 12 is a sequence diagram illustrating still another example of the printing sequence.

### DESCRIPTION OF EMBODIMENTS

Embodiments of the present disclosure will be described in the following order.

1. Configuration of Printing System:

1-1. Configuration of Printing Apparatus:

1-2. Configuration of Printing Control Apparatus:

2. Printing Sequence:

3. Other embodiments:

1. Configuration of Printing System:

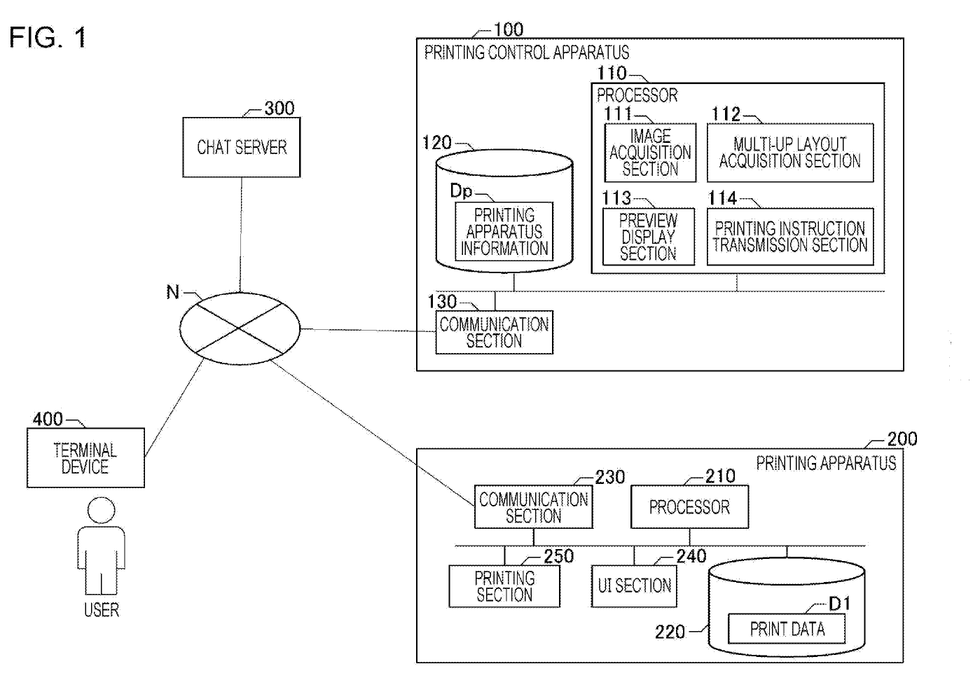

FIG. 1 is a block diagram illustrating a configuration of a printing system according to an embodiment of the present disclosure. The printing system includes a printing control apparatus 100 and a printing apparatus 200. The printing control apparatus 100 and the printing apparatus 200 can communicate with each other via a network N. Further, the printing control apparatus 100 can communicate with a chat server 300 via the network N. The chat server 300 is a server that provides a chat service in which a message is exchanged with a partner in a conversation format. A user of the chat service installs an application (chat application) for using the chat service on a terminal device 400 owned by the user, and creates a user account for the chat service. The terminal device 400 communicates with the chat server 300 via the network N by executing the chat application.

The terminal device 400 is a device configured to execute the chat application, and may be, for example, a smartphone, a tablet, a PC, or the like. The terminal device 400 is provided with a camera (not illustrated), a communication section, a touch panel display, and a storage medium. In addition, the terminal device 400 has a screenshot function of storing an entire screen displayed on the touch panel display as an image file by a predetermined screenshot operation on the touch panel display.

When the user of the terminal device 400 approves an account of a chat bot that performs a process preset by a developer of the printing control apparatus 100 in the chat application as a chat partner, the user can use a chat printing service provided by the printing control apparatus 100 by exchanging a message with the chat bot. In the chat printing service, the user registers the printing apparatus 200 to be used for printing in advance. With the chat printing service, the user can cause the registered printing apparatus 200 to print an image as a print target by interacting with the chat bot in the chat application.

Meanwhile, when the file as a print target is an image based on an extension or the like of the file as a print target, a use form for printing on photo paper is mainly assumed in the related art. Therefore, a default print setting of a printing medium when printing an image is generally photo paper. Meanwhile, depending on a content of the image, there is also a use form in which printing is performed on plain paper instead of photo paper. Specifically, for example, the use form is a form in which the user takes a screenshot of a search result on the Internet, a chat history of the chat application or the like on the terminal device 400 as a memorandum and stores the screenshot image, and prints the stored screenshot image. In such a case, the user has a request that the screenshot image is to be printed on plain paper instead of photo paper. Meanwhile, in the related art, when printing a screenshot image, it is necessary to change a print setting related to a printing medium from a default photo paper to a plain paper each time, and it is desired to improve the convenience. In addition, it is desired to realize multi-up printing in which a plurality of images are assigned within one page and printed in a chat printing service. Hereinafter, a configuration and a processing content of the printing system for realizing these functions will be described.

### 1-1. Configuration of Printing Apparatus:

The printing apparatus 200 includes a processor 210, a storage medium 220, a communication section 230, a UI section 240, and a printing section 250. The processor 210 includes a CPU, a ROM, a RAM, and the like (not illustrated), and controls each section of the printing apparatus 200 by executing a control program stored in the storage medium 220. The processor 210 may be configured with a single chip or a plurality of chips, or may be configured as an SoC together with various functional blocks for operating the printing apparatus 200. Further, an ASIC may be adopted instead of the CPU, or a configuration may be adopted in which the CPU and the ASIC cooperate with each other. When each apparatus in the present embodiment includes a processor, the processor can be achieved in various aspects as in the processor 210.

Various programs or various types of control data executed by the processor 210 are stored in the storage medium 220. Further, print data D1 transmitted from the terminal device 400 is stored in an operation process of the printing system. The communication section 230 includes a circuit used for communication according to various wired or wireless communication protocols with another apparatus. In the present embodiment, the printing apparatus 200 can communicate with the printing control apparatus 100 via the network N by the communication section 230. The UI section 240 includes a touch panel display, a key, and the like for displaying various types of information to the user and for inputting an operation of the user.

The printing section 250 includes an actuator, a driving component, a mechanical component, various sensors, and the like for ejecting inks to a printing medium and performing printing. A sensor for detecting a state of the printing apparatus 200 includes, for example, a sensor that detects a type of printing medium such as a size of the printing medium set in a paper feeding section, a sensor that detects the remaining amount of printing medium, a sensor that detects a jam in a transport path of the printing medium, a sensor that detects the remaining amount of ink, and the like. The processor 210 controls the printing section 250 to execute printing based on the print data. In the present embodiment, the printing section 250 that performs printing by an ink jet method is assumed, but the printing method is not limited thereto.

When receiving the print data D1 from the printing control apparatus 100, the processor 210 controls the printing section 250 and executes printing based on the print data D1. Further, the processor 210 transmits information indicating a progress or a success or failure of a print job to the printing control apparatus 100 in response to an inquiry from the printing control apparatus 100. Further, the processor 210 transmits, to the printing control apparatus 100, information indicating a printing capability of the printing apparatus 200 in response to an inquiry from the printing control apparatus 100. The information indicating the printing capability is information for the printing apparatus 200 to determine whether or not printing can be performed on the printing medium having a predetermined size and a predetermined type. In the present embodiment, the information indicating the printing capability includes, for example, information indicating a model of the printing apparatus 200 and information indicating a state of the printing apparatus 200. Depending on the model, printing on A4 plain paper may not be available since the model is a photo printer. In addition, for example, even when the remaining amount of A4 plain paper is 0 in a paper feed tray of A4 plain paper, it is indicated that printing on A4 plain paper is not available. The processor 210 can acquire, for example, model information stored in a ROM. The processor 210 can acquire the state of the printing apparatus 200 based on an output of a sensor of the printing section 250.

### 1-2. Configuration of Printing Control Apparatus:

In the present embodiment, the printing control apparatus 100 is a server for realizing a chat printing function via the chat server 300. The printing control apparatus 100 may be configured by a plurality of servers. The printing control apparatus 100 includes a processor 110, a storage medium 120, and a communication section 130. The processor 110 includes a CPU, a ROM, a RAM, and the like, and can execute various programs stored in the ROM or the storage medium 220 by the CPU. The communication section 130 is a communication interface for communicating with another apparatus. The printing control apparatus 100 can communicate with the other apparatus coupled to the network N via the communication section 130.

The storage medium 120 stores printing apparatus information Dp of the printing apparatus 200. The printing apparatus information Dp includes information indicating a printing capability of the printing apparatus 200, information indicating a print setting related to printing execution by the printing apparatus 200, or the like, and is acquired from the printing apparatus 200 and stored in the storage medium 120. The information indicating the print setting includes information indicating a type of printing medium used when an image file is printed by the printing apparatus 200 in the present embodiment. Information indicating the printing medium used when the image file is printed by the printing apparatus 200 may be a default value, that is, an initial value preset by the manufacturer, or may be a value set by the user. For example, when a print target is an image file, it may be assumed that the print setting is defined as printing an image indicated by the image file on photo paper or the like.

The processor 110 functions as an image acquisition section 111, a multi-up layout acquisition section 112, a preview display section 113, and a printing instruction transmission section 114 by executing a printing control program (not illustrated) for realizing the chat printing function.

The image acquisition section 111 is a function of acquiring an image selected as a print target in the terminal device 400 via the chat server 300. More specifically, the processor 110 causes the image acquisition section 111 to display a list of images stored in the terminal device 400 on the terminal device 400, and acquires an image selected by the user as the print target from the list.

The multi-up layout acquisition section 112 is a function of displaying a plurality of multi-up layouts as candidates on the terminal device 400 and acquiring a multi-up layout selected from the candidates. The preview display section 113 is a function of displaying a preview image in which the selected image is arranged according to the multi-up layout on the terminal device 400.

The printing instruction transmission section 114 is a function of transmitting a printing instruction for the image acquired as the print target to the printing apparatus 200. More specifically, the processor 110 generates print data in which the print target image is arranged according to the multi-up layout by a function of the printing instruction transmission section 114, and transmits an instruction to print the print data to the printing apparatus.

At least one of the image acquisition section 111, the multi-up layout acquisition section 112, and the preview display section 113 is processed via the chat server 300. By being processed via the chat server 300, a processing content in the process of at least one of the image acquisition section 111, the multi-up layout acquisition section 112, and the preview display section 113 can be configured to be displayed as a type of message in a chat room between an account of a chat bot of the printing control apparatus 100 and an account of the user. With such a configuration, what kind of image the user selects as the print target or what kind of multi-up layout the user selects when executing chat printing, or what kind of print preview is, or the like can remain as a history in the chat room. As a result, according to this configuration, the user can easily review the history of multi-up printing in the past chat printing.

Further, the processor 110 transmits a printing instruction to print the print target image on plain paper when the print target image is input to the chat room in a state in which a first menu is selected from the chat room in the terminal device 400 by the function of the printing instruction transmission section 114, and transmits a printing instruction to print the print target image on photo paper when the print target image is input to the chat room in a state in which a second menu is selected from the chat room in the terminal device 400.

That is, in the present embodiment, a print menu is displayed in a selectable manner in the chat room of the account of the chat bot of the printing control apparatus 100 and the account of the user. The print menu includes the first menu and the second menu. The first menu is mainly a print menu assuming multi-up printing of a screenshot image in the present embodiment, and is a print menu for printing the print target image on plain paper by selecting the first menu, regardless of a content of the print setting for the printing apparatus 200. Regardless of the content of the print setting for the printing apparatus 200 indicates that, for example, a default printing medium when the image file is printed by the printing apparatus 200 or a printing medium set by the user is not related to a type of printing medium. Even when the user selects the first menu and causes the printing apparatus 200 to execute printing, the print setting preset for the printing apparatus 200 is held without being changed. In the present embodiment, the second menu is, for example, a print menu assuming that an image is printed on photo paper, and by selecting the second menu, the user can print the image as a print target on photo paper in the printing apparatus 200. In this manner, regarding image printing, the first menu for printing on plain paper and the second menu for printing on photo paper are selectable and presented in the chat room. The user selects the first menu and selects an image as a print target, so that the image as a print target can be printed on plain paper without changing the setting of the printing medium to print on plain paper each time the screenshot image is printed. Of course, the user can print the image on photo paper by selecting the second menu and selecting the image as a print target.

### 2. Printing Sequence:

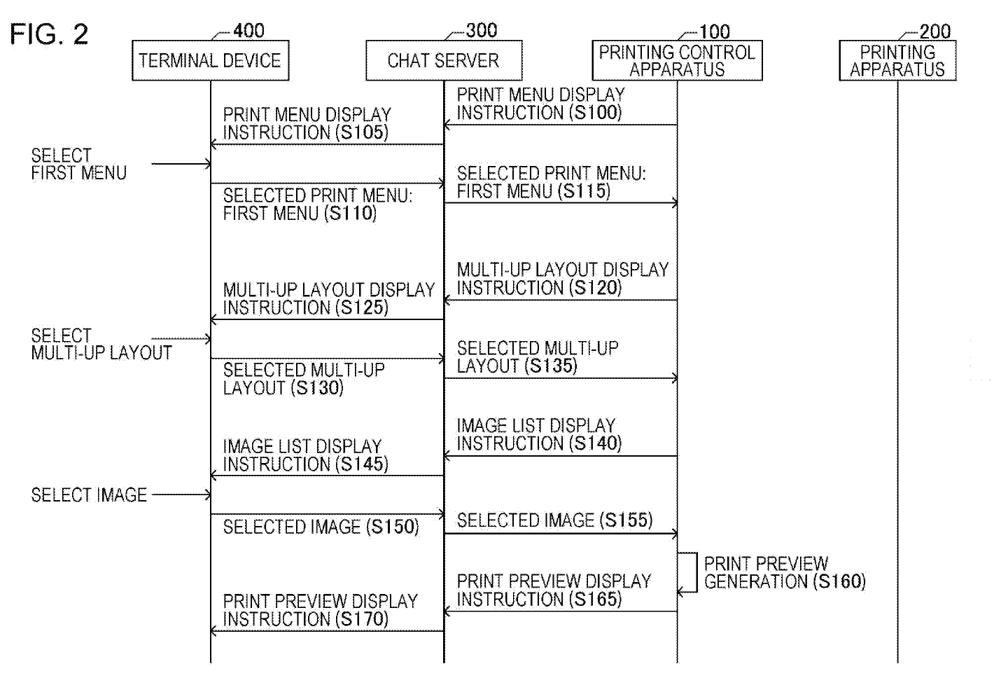

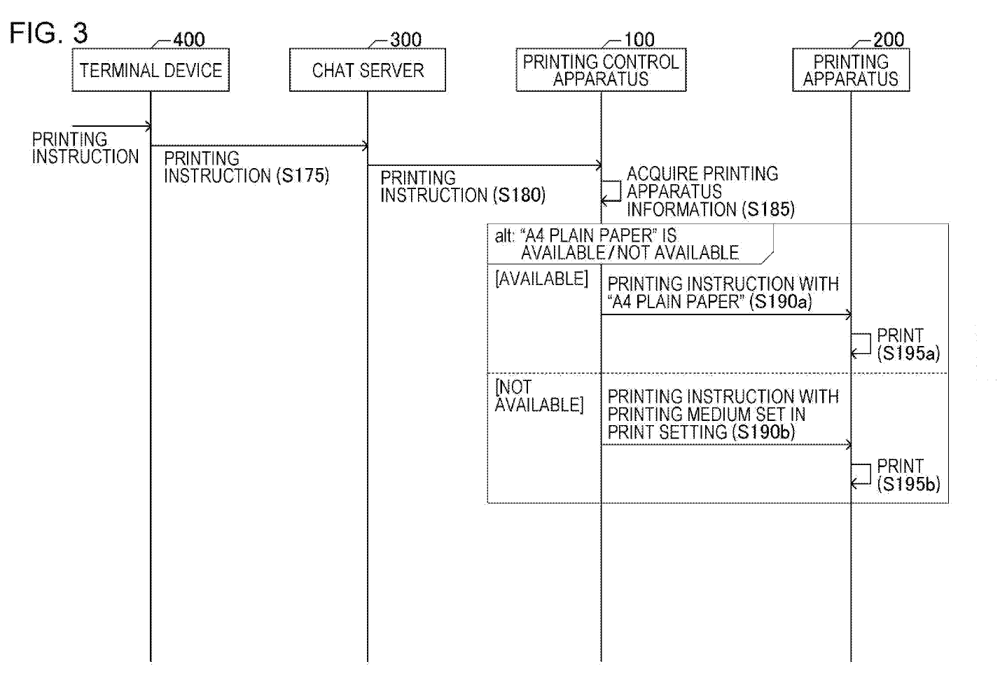

FIGS. 2 and 3 are sequence diagrams illustrating a schematic processing flow of each apparatus when multi-up printing of a screenshot image is performed. In the present embodiment, as illustrated in FIG. 2, an example in which all of the image acquisition section 111, the multi-up layout acquisition section 112, and the preview display section 113 perform a process via the chat server 300 will be described.

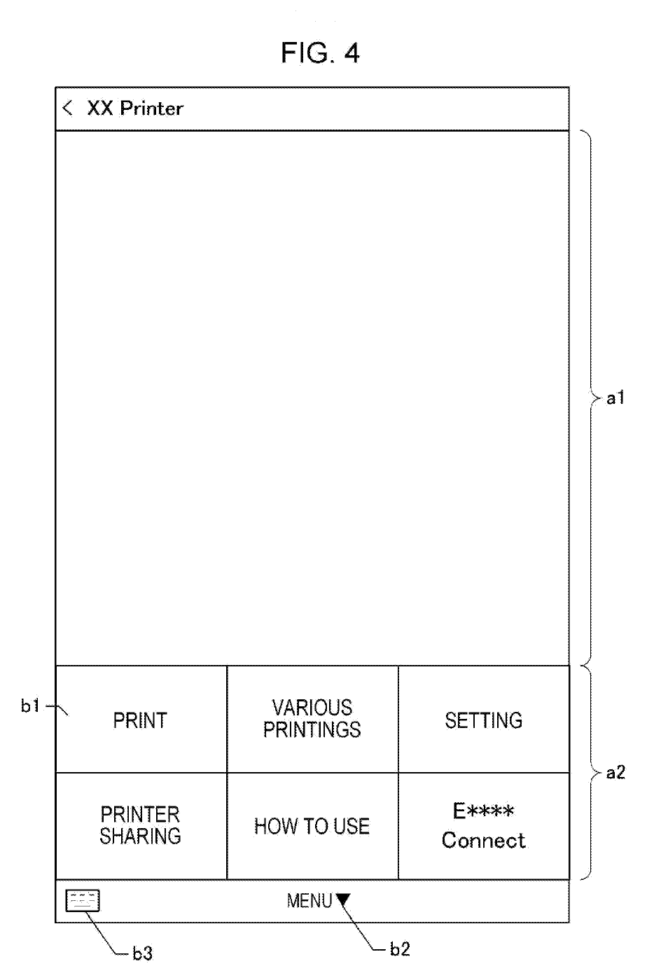

FIG. 4 is a diagram illustrating a display example of a chat room displayed on the terminal device 400 used by a user, which is a chat room of an account "XX Printer" of a chat bot of the printing control apparatus 100 and an account of the user who tries to cause the printing apparatus 200 to execute printing by using a printing system.

When the user operates the terminal device 400 to start a chat application and open the chat room with the chat bot account of the printing control apparatus 100, the chat room as illustrated in FIG. 4 is displayed on the terminal device 400. As illustrated in FIG. 4, the chat room includes a menu section a2 and a chat section a1. In the chat section a1, messages in a conversation format exchanged with the account of the printing control apparatus 100 are displayed in time series. A new message is displayed below in the chat section a1. When the new message is input, a chat history is moved to an upper side of the chat section a1 and displayed. An old message that cannot be displayed within a range of the chat section a1 is not displayed, and when the user swipes the chat section a1 in a direction from the top to the bottom of the screen, the old message out of the display range can also be displayed.

The menu section a2 is configured to include a plurality of menu buttons for using various functions provided by the printing control apparatus 100 with respect to chat printing. The menu section a2 includes a print button b1 for executing printing according to a guidance for each print menu described above. In order to tap the print button b1 and perform printing according to the guidance, the user performs registration of the printing apparatus 200 that the user causes to execute printing in advance.

A button b2 is a button for turning on and off the display of the menu section a2. A button b3 is a button for displaying a character input section for inputting any character string in the chat room.

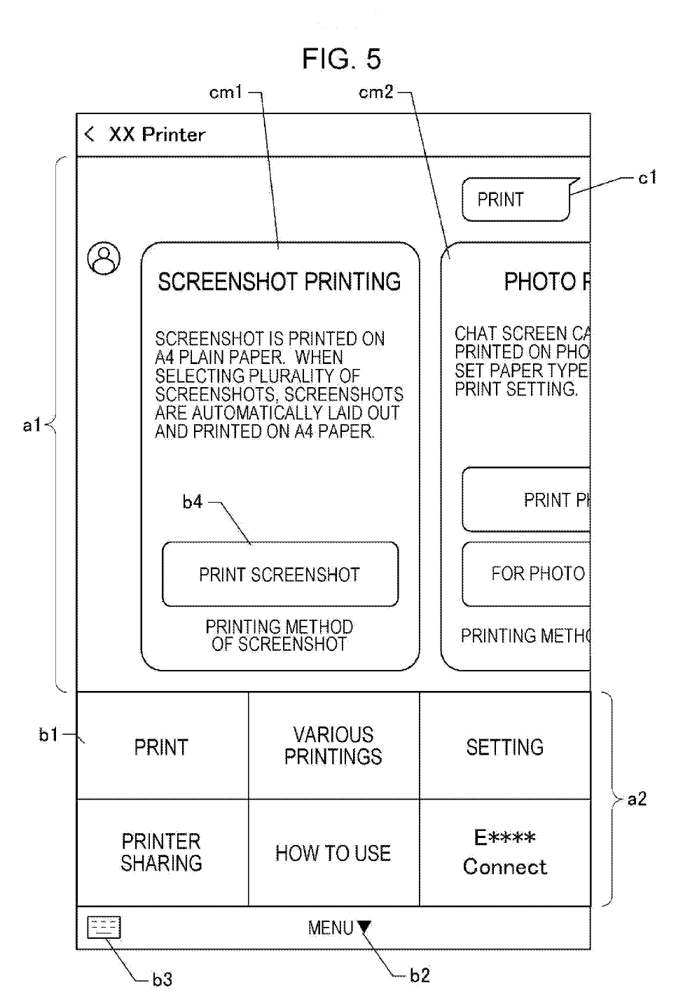

When the user selects the print button b1, the terminal device 400 notifies the printing control apparatus 100 that the print button b1 is selected via the chat server 300. Upon receiving the notification, the processor 110 of the printing control apparatus 100 transmits a display instruction of the print menu to the terminal device 400 via the chat server 300 (step S100 and step S105). FIG. 5 is a diagram illustrating a display example of the print menu displayed on the display of the terminal device 400 when the terminal device 400 receives the display instruction in step S105.

As illustrated in FIG. 5, the terminal device 400 displays a message c1 indicating that the user has selected the print button b1 in the chat section a1, and then displays cm1 and cm2 indicating the print menu in the chat section a1. In a print menu section such as cm1 and cm2, a range displayed in the chat section a1 is changed by swiping in a left-right direction of the screen. FIG. 5 illustrates an example in which the first menu section cm1 and a part of the second menu section cm2 are displayed.

In the present embodiment, the first menu is a print menu used when an image is printed on A4 plain paper. The second menu is a print menu used when printing the image on photo paper. The print menu may include various other menus, but the illustration and description thereof will be omitted.

The first menu is a menu assumed to print a screenshot image on A4 plain paper, and the first menu section cm1 includes a description of a function that can be executed by selecting the print menu and a button b4 for proceeding with printing by the first menu according to a guidance. When the user selects the button b4, the terminal device 400 transmits information indicating that the selected print menu is the first menu to the printing control apparatus 100 via the chat server 300 (steps S110 and S115 in FIG. 2).

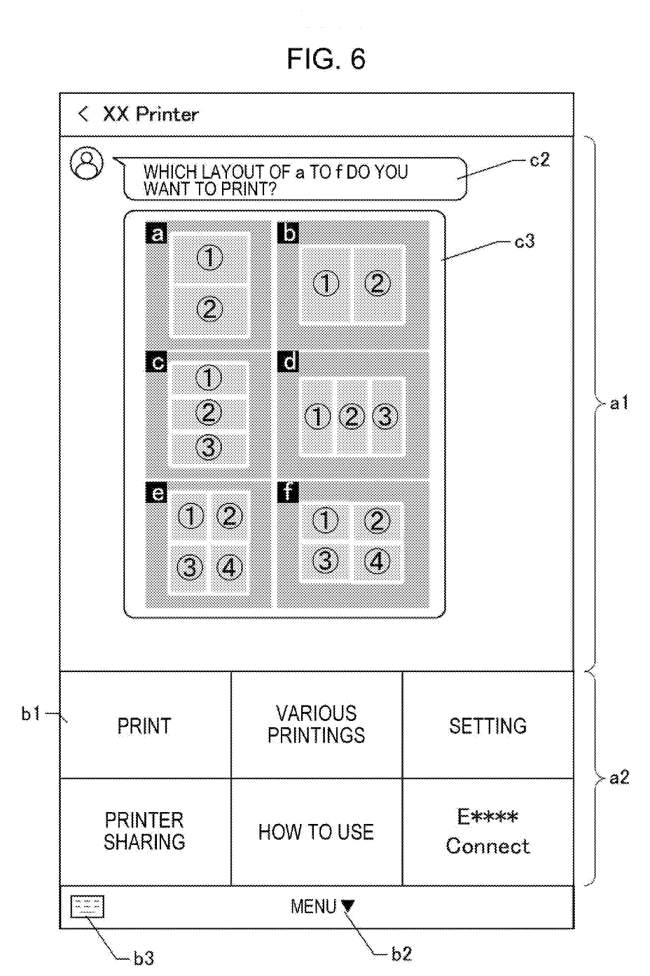

When the information indicating that the first menu is selected is acquired, the processor 110 of the printing control apparatus 100 transmits a multi-up layout display instruction to the terminal device 400 via the chat server 300 by a function of the multi-up layout acquisition section 112 (steps S120 and S125 in FIG. 2). FIG. 6 is a diagram illustrating a display example of a message prompting a user to select from candidates for the multi-up layout displayed by the terminal device 400 in response to the display instruction in step S125.

For example, the terminal device 400 displays, in the chat section a1, a message prompting the user to select a multi-up layout as illustrated in messages c2 and c3, or options illustrating multi-up layouts, in response to the multi-up layout display instruction. For example, the message c3 indicates that each image indicates the candidates for the six multi-up layouts to which a to f are respectively assigned is included. A number illustrated in each layout indicates a multi-up order of the images.

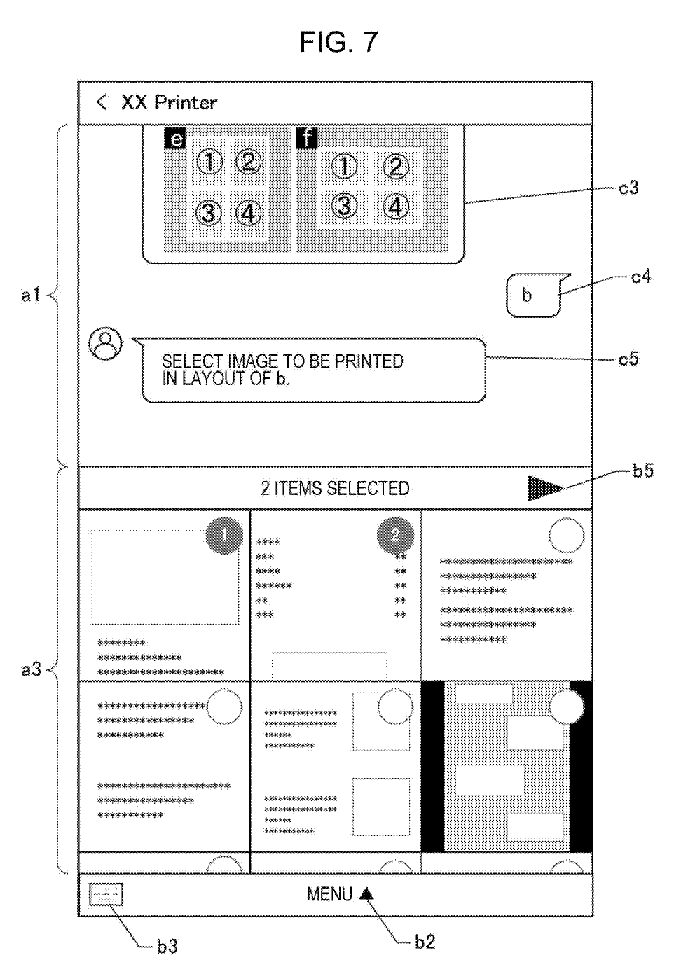

Each of the images illustrating the six multi-up layouts may be associated with an action when tapped. For example, a multi-up layout associated with the tapped image may be configured to be acquired as a selection of the user. More specifically, for example, when a region of a multi-up layout image to which "b" is assigned is tapped, in the terminal device 400, it is considered that a multi-up layout corresponding to "b" is selected by the user, and as illustrated in FIG. 7, as a message of the user, a message c4 indicating that "b" is selected is displayed in the chat section a1. Alternatively, for example, in a state illustrated in FIG. 6, the button b3 for displaying a character input section (not illustrated) may be selected by the user, the user may input a character "b" indicating the selection of the user by operating the character input section, and as a result, the message c4 illustrated in FIG. 7 may be displayed.

The aspect of presenting the candidate for the multi-up layout and the aspect of selecting from the candidates illustrated in FIG. 6 are merely examples. It is sufficient that the multi-up layout selected by the user may be displayed in a chat room as a history, and the multi-up layout may be appropriately designed according to a specification of the chat server or the like. In addition, the example of the candidate for the multi-up layout is only an example. Any of the six types of multi-up layouts may be presented, or a multi-up layout other than the six types may be presented.

The terminal device 400 transmits information indicating the multi-up layout selected by the user to the printing control apparatus 100 via the chat server 300 (steps S130 and S135). When acquiring the information indicating the multi-up layout in step S135 by the function of the multi-up layout acquisition section 112, the processor 110 of the printing control apparatus 100 transmits an image list display instruction to the terminal device 400 via the chat server 300 by a function of the image acquisition section 111 (steps S140 and S145). The image list display instruction is an instruction to display a list of images stored in the terminal device 400. The display of the image list is performed to allow the user to select the image as a print target.

A message c5 displayed in the chat section a1 in FIG. 7 illustrates an example of a message prompting the user to select a print target image to be displayed by the terminal device 400, in response to the display instruction in step S145. Further, in response to the display instruction in step S145, the terminal device 400 displays an image list display section a3 at a lower portion of the chat room as illustrated in FIG. 7. The image list display section a3 may be configured to be displayed in response to the user selecting a button (not illustrated) for displaying the image list.

The image list display section a3 illustrated in FIG. 7 illustrates an example in which a list of thumbnails of images stored in the storage medium of the terminal device 400 is displayed side by side. The image displayed on the image list display section a3 is an image of a file having an extension indicating that the file is an image, and may include various images such as a screenshot image and an image captured by a camera included in the terminal device 400.

In the example illustrated in FIG. 7, the fact that a thumbnail in an upper left portion and a thumbnail in an upper center portion are selected in this order is indicated among the thumbnails displayed side by side on the image list display section a3. When a transmission button b5 is tapped in a state in which the two thumbnails are selected, the terminal device 400 transmits each image file corresponding to the selected thumbnail to the printing control apparatus 100 via the chat server 300 (steps S150 and S155 in FIG. 2). Specifically, for example, when the chat server 300 receives the image file indicating the image selected from the terminal device 400 in step S150, the chat server 300 transmits a notification to the printing control apparatus 100 that the image is posted in the chat room. The printing control apparatus 100 transmits an image acquisition request to the chat server 300 in response to the notification, and the chat server 300 transmits the image file indicating the image posted to the printing control apparatus 100 in response to the acquisition request. As a result, the processor 110 of the printing control apparatus 100 acquires the image file by the function of the image acquisition section 111.

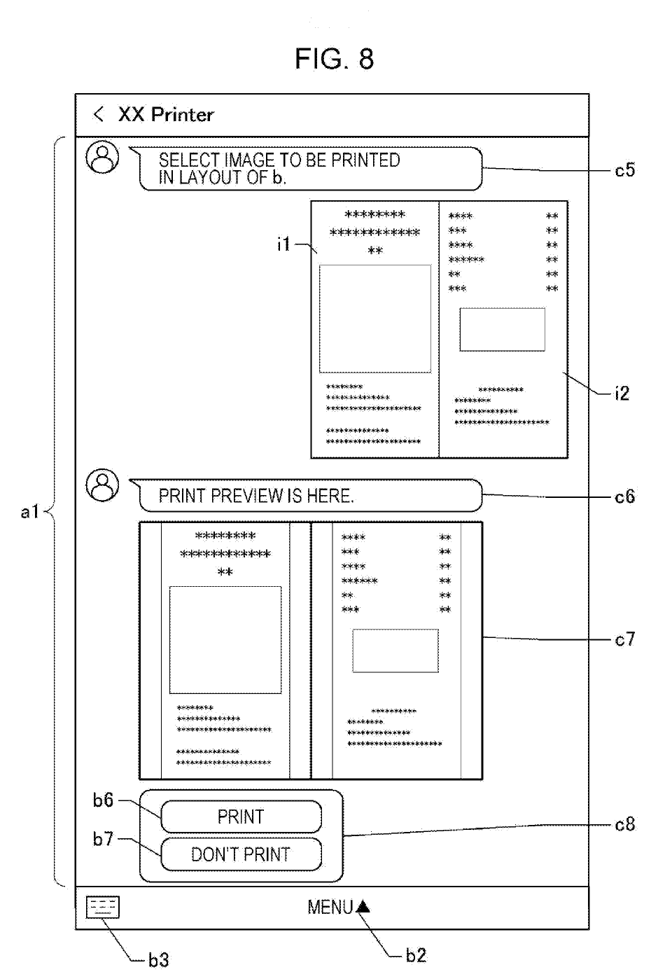

i1 and i2 illustrated in FIG. 8 are diagrams illustrating display examples of images transmitted from the terminal device 400. When the user selects any image in the image list displayed on the image list display section a3 illustrated in FIG. 7 and taps the transmission button b5, the selected images i1 and i2 are displayed in the chat section a1.

In this manner, in the present embodiment, the process by the multi-up layout acquisition section 112 is executed before the process by the image acquisition section 111. Therefore, according to the present embodiment, the user can determine a multi-up layout, and then select an image to be assigned in the layout and perform printing.

When acquiring the print target image selected by the user in step S155 in FIG. 2, the processor 110 of the printing control apparatus 100 generates a print preview based on the image and the multi-up layout acquired in step S135 by a function of the preview display section 113 (step S160). In the present embodiment, an order of the images to be arranged in accordance with the multi-up layout is determined in the order in which the images are selected from the image list illustrated in FIG. 7. Specifically, for example, as illustrated by "b" in the message c3 in FIG. 6, when a multi-up layout in which two portrait multi-up regions are arranged is selected for a landscape printing medium, and two images are selected from the image list as illustrated in FIG. 7, a first selected image is assigned to a first position in the multi-up layout, and a second selected image is assigned to a second position in the multi-up layout. The processor 110 generates a preview image in which the image is assigned to the multi-up region in this manner. Therefore, the user can recognize that a printed matter in which the images are assigned in order of the selection of the images is obtained by the print preview.

When the print preview is generated in step S160, the processor 110 of the printing control apparatus 100 transmits a print preview display instruction to the terminal device 400 via the chat server 300 by the function of the preview display section 113 (steps S165 and S170). In response to the display instruction in step S170, the terminal device 400 displays the print preview on the display of the terminal device 400. c6 illustrated in FIG. 8 is an example of a message prompting a check for the print preview. c7 illustrated in FIG. 8 is a display example of the print preview. c8 illustrated in FIG. 8 includes buttons b6 and b7 for causing the user to select whether or not to execute printing indicated by the print preview. The button b6 is a button for selecting printing, and the button b7 is a button for selecting non-printing. The aspect illustrated in c8 is only an example. An aspect in which the user selects whether or not to execute printing may be appropriately designed based on the specification of the chat server or the like.

FIG. 3 illustrates a sequence example continuing from step S170 in FIG. 2. When the user selects to execute printing by tapping the button b6, that is, when a printing instruction is input, the terminal device 400 transmits the printing instruction to the printing control apparatus 100 via the chat server 300 (steps S175 and S180). When the button b7 is tapped, the printing instruction is not transmitted.

The processor 110 of the printing control apparatus 100 acquires the printing apparatus information Dp of the printing apparatus 200 by the function of the printing instruction transmission section 114 (step S185). Specifically, for example, the processor 110 refers to information indicating a printing capability of the printing apparatus 200, which is acquired in advance and stored in the storage medium 120. The processor 110 may be configured to acquire information indicating a state of the printing apparatus 200 in the information indicating the printing capability by inquiring the printing apparatus 200 of the state of the printing apparatus 200 in step S185. Further, the processor 110 refers to information indicating a print setting related to the printing execution in the printing apparatus 200 stored in the storage medium 120.

When the information indicating the printing capability in the printing apparatus information Dp of the printing apparatus 200 indicates that printing on A4 plain paper is available, the processor 110 of the printing control apparatus 100 transmits a printing instruction to print on "A4 plain paper" to the printing apparatus 200 by the function of the printing instruction transmission section 114 (step S190a). Specifically, the processor 110 generates print data for causing the printing apparatus 200 to execute printing on A4 plain paper based on the multi-up layout acquired in step S135 and the image acquired in step S155, and transmits the print data to the printing apparatus 200. When the printing instruction is received in step S190a, the printing apparatus 200 executes printing on A4 plain paper based on the received print data (step S195a). That is, the sequences in FIGS. 2 and 3 are sequences when the user selects the first menu, and the processor 110 causes the printing apparatus 200 to print on A4 plain paper based on the print data when printing on A4 plain paper is available. Therefore, the user can print the selected image on A4 plain paper regardless of a content of a print setting related to a printing medium of the printing apparatus 200 by selecting the first menu and selecting the image as a print target. When the first menu is selected and the printing apparatus 200 can print on A4 plain paper, the user does not need to change the setting related to the printing medium, and thus the convenience for the user is improved as compared with the related art.

When the information indicating the printing capability of the printing apparatus 200 indicates that printing on A4 plain paper is not available, the processor 110 of the printing control apparatus 100 transmits a printing instruction to the printing apparatus 200 to print on the printing medium set in a print setting related to the printing apparatus 200, that is, a printing medium preset as a printing medium used when an image file is printed, by the function of the printing instruction transmission section 114 (step S190b). Specifically, the processor 110 refers to information indicating the print setting of the printing apparatus information Dp, and acquires the printing medium designated in advance as the printing medium used when printing the image file for the printing apparatus 200. The processor 110 generates print data for printing on the printing medium set in the print setting based on the multi-up layout acquired in step S135 and the image acquired in step S155, and transmits the print data to the printing apparatus 200. When the printing instruction in step S190b is received, the printing apparatus 200 executes printing based on the print data (step S195b). With such a configuration, when printing on plain paper by the printing apparatus 200 is not available even when printing for the first menu is instructed, the printing can be executed on the printing medium set in a print setting of the printing apparatus 200.

When an image is input to the chat room in a state in which the second menu is selected from the chat room in the terminal device 400, the processor 110 transmits a printing instruction for printing the image on photo paper by the function of the printing instruction transmission section 114. Specifically, when the user selects the second menu after step S105 in FIG. 2, the processor 110 generates print data for printing on photo paper based on the image selected as the print target, and transmits the print data to the printing apparatus 200. In this case, of course, it may be configured to determine whether or not printing on photo paper is available based on the information indicating the printing capability of the printing apparatus 200 and to transmit the printing instruction to print on photo paper when printing on photo paper is available.

Further, in the present embodiment, the processes of the image acquisition section 111, the multi-up layout acquisition section 112, and the preview display section 113 are performed via the chat server 300, and thus, as in the display examples illustrated in FIGS. 6, 7, and 8, the history of the selection of the user when executing multi-up printing of the screenshot image can remain in the chat section a1. Therefore, the user can easily review on what selection is made in the process of instructing multi-up printing by swiping the chat section a1.

### 3. Other embodiments:

The above embodiment is an example for executing the present disclosure, and various other embodiments can be adopted. For example, the printing control apparatus may be configured by a plurality of devices. Further, a plurality of printing apparatuses to be used for the chat printing service may be present for one user.

The image selected in the first menu is not limited to the screenshot image. For example, when the user wants to print an image captured by a camera on plain paper as a memorandum instead of for viewing, the user can use the first menu to print the image captured by the camera. The first menu is not limited to the printing in which a plurality of print target images are assigned on one page of the printing medium and printed. A pattern of printing by arranging one image on one page may be included.

In the above embodiment, all the processes of the image acquisition section 111, the multi-up layout acquisition section 112, and the preview display section 113 are performed via the chat server 300, but any of the processes may be configured to be processed by communicating with the terminal device 400 without going through the chat server 300. In the image acquisition section 111, the multi-up layout acquisition section 112, and the preview display section 113, a selection of a process to be performed via the chat server 300 and a process to be performed without going through the chat server 300 may be appropriately designed.

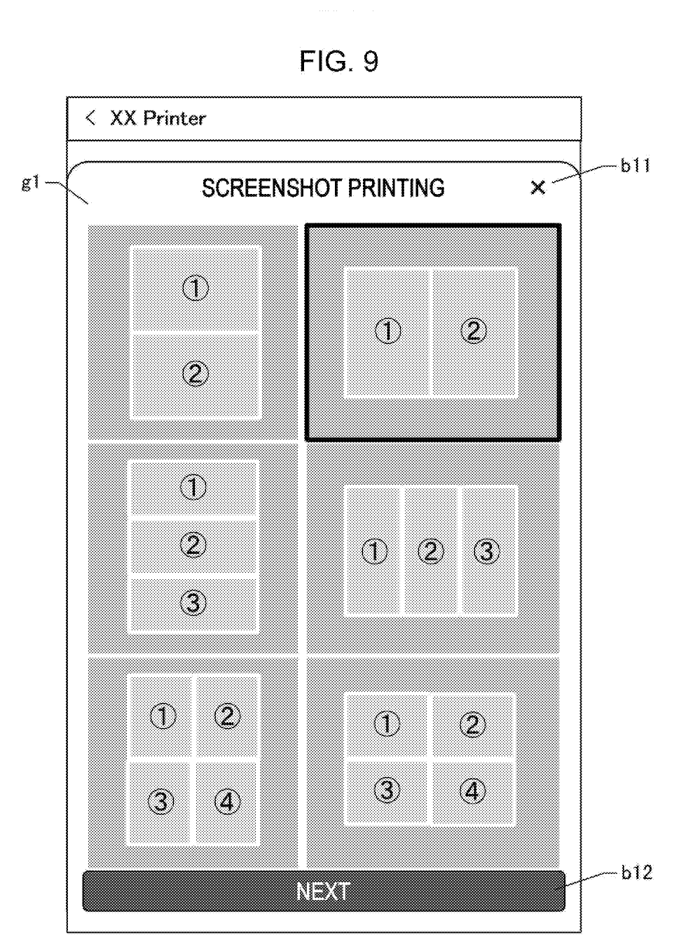

For example, FIG. 9 is a display example when the process of the multi-up layout acquisition section 112 is processed without going through the chat server 300. A screen g1 illustrated in FIG. 9 is, for example, a screen displayed in an overlapping manner with a region of the chat section a1 or the menu section a2 when the button b4 is selected in a state in which the display illustrated in FIG. 5 is performed by the terminal device 400. The screen g1 is, for example, an internal browser of the chat application. When the button b4 is selected, the terminal device 400 transmits a display request for the screen g1 to the printing control apparatus 100, the printing control apparatus 100 transmits display data of the screen g1 to the terminal device 400 in response to the display request, and the terminal device 400 displays the screen g1 based on the display data. When a close button b11 is tapped, the terminal device 400 ends the display of the screen g1, and as a result, for example, the screen of the terminal device 400 returns to the display illustrated in FIG. 5. The screen g1 displays images indicating a plurality of multi-up layouts as options. When any of the options is selected by the user and the button b12 for proceeding to the next is tapped, the terminal device 400 transmits information indicating the selected multi-up layout to the printing control apparatus 100 without going through the chat server 300. In this manner, the printing control apparatus 100 may be configured to perform the process of the multi-up layout acquisition section 112 without going through the chat server 300.

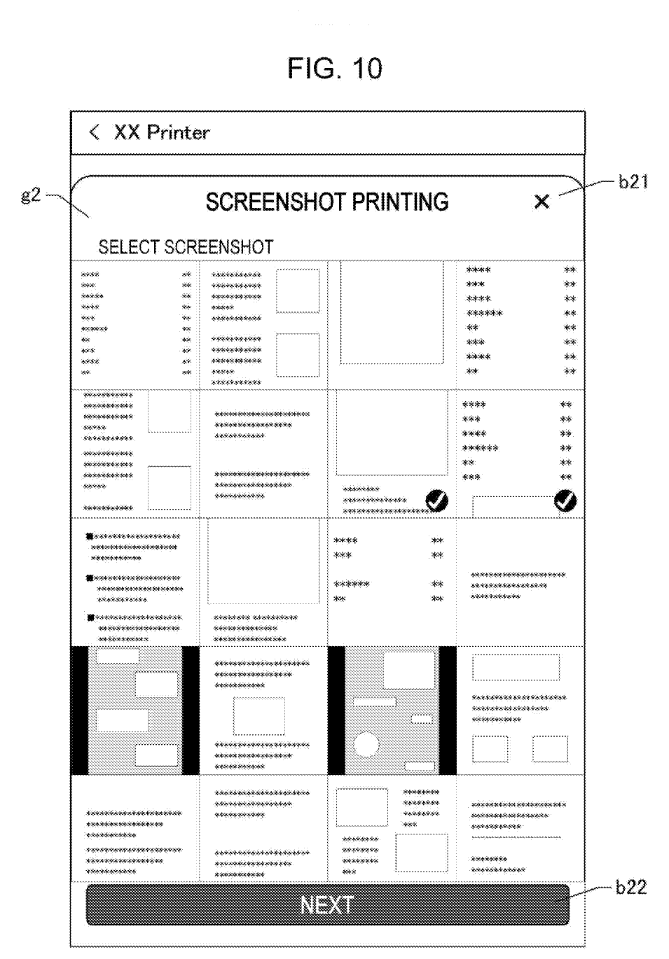

FIG. 10 illustrates a display example when a process of the image acquisition section 111 is performed without going through the chat server 300. A screen g2 illustrated in FIG. 10 is a screen displayed in an overlapping manner with the region of the chat section a1 or the menu section a2 when a print target image is selected from an image list stored in the terminal device 400. When the image list is displayed and the print target image is selected, the terminal device 400 transmits a display request for the screen g2 to the printing control apparatus 100, the printing control apparatus 100 transmits display data of the screen g2 to the terminal device 400 in response to the display request, and the terminal device 400 displays the screen g2 based on the display data. When a close button b21 is tapped, the terminal device 400 ends the display of the screen g2. The image list stored in the terminal device 400 is displayed on the screen g2. When any of the images is selected by the user and the button b22 for proceeding to the next process is tapped, the terminal device 400 transmits an image file indicating the selected image to the printing control apparatus 100 without going through the chat server 300. In this manner, the printing control apparatus 100 may be configured to perform the process of the image acquisition section 111 without going through the chat server 300.

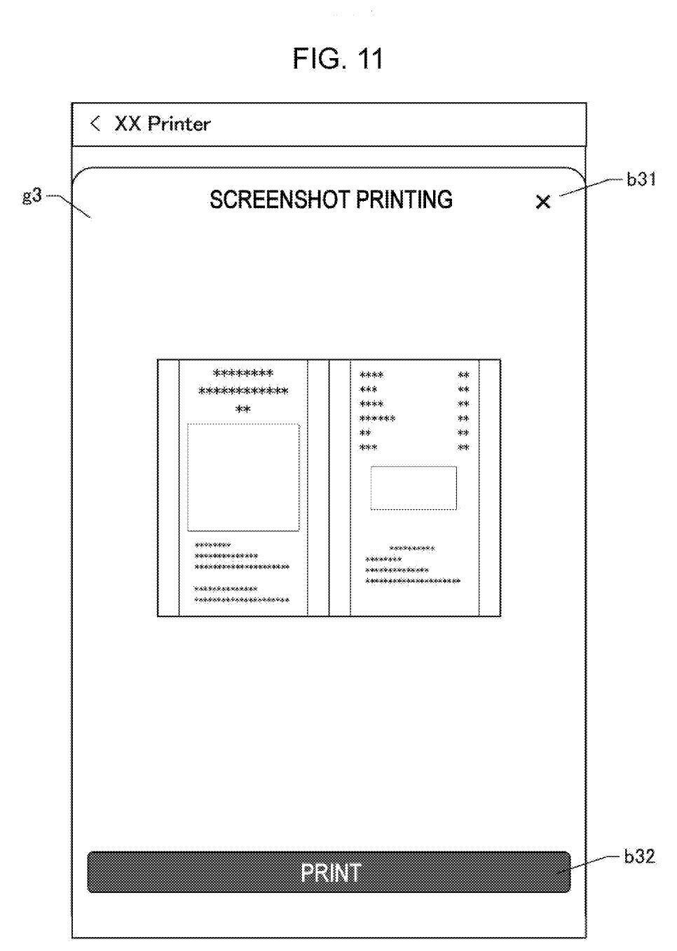

FIG. 11 illustrates a display example when a process of the preview display section 113 is processed without going through the chat server 300. A screen g3 illustrated in FIG. 11 is a screen displayed in the region of the chat section a1 or the menu section a2 when a print preview generated by the terminal device 400 is displayed in the terminal device 400. When the print preview is displayed, the terminal device 400 transmits a display request for the screen g3 to the printing control apparatus 100, the printing control apparatus 100 transmits display data for the screen g3 to the terminal device 400 in response to the display request, and the terminal device 400 displays the screen g3 based on the display data. When a close button b31 is tapped, the terminal device 400 ends the display of the screen g3. On the screen g3, a print preview when the image selected by the user is assigned is displayed according to the multi-up layout selected by the user. When the user selects a print button b32, the terminal device 400 transmits a printing instruction to the printing control apparatus 100 without going through the chat server 300. In this manner, the printing control apparatus 100 may be configured to perform the process of the preview display section 113 without going through the chat server 300.

In the above embodiment, an example is described in which the process of the multi-up layout acquisition section is performed before the process of the image acquisition section is performed. Meanwhile, the process of the image acquisition section may be performed before the process of the multi-up layout acquisition section is performed. With such a configuration, the user can select an image to be printed, and then determine a multi-up layout of the selected image.

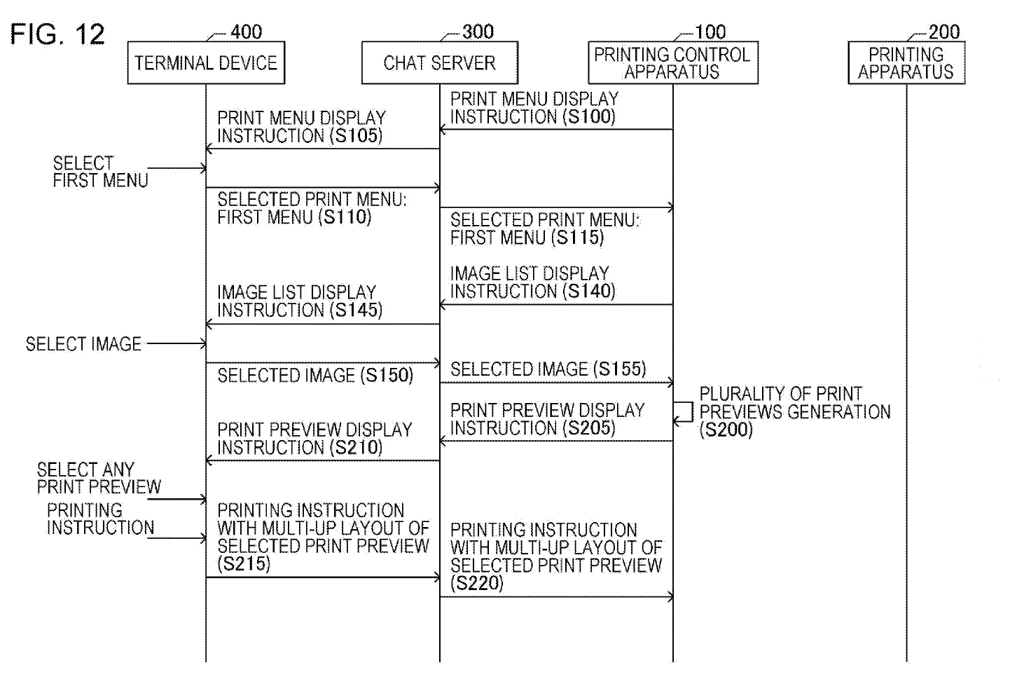

When the process of the image acquisition section is executed before the process of the multi-up layout acquisition section, the multi-up layout acquisition section may be configured to acquire a candidate for a multi-up layout according to the number of selected images, generate a preview image for the candidate in the preview display section to display the preview image on the terminal device, and acquire a multi-up layout adopted in the print preview selected by the user among the displayed preview images. In this case, the printing instruction transmission section may be configured to generate print data in which the selected image is arranged according to the acquired multi-up layout, and transmit a printing instruction of the print data to the printing apparatus. FIG. 12 illustrates an example of a printing sequence when the printing sequence is configured as described above.

In steps S100 to S115 illustrated in FIG. 12, the same process as the same steps of the above embodiment may be performed. When it is acquired in step S115 that the first menu is selected, the processor 110 transmits an image list display instruction by the function of the image acquisition section 111. In Steps S140 to S155, the same process as in the same steps of the above embodiment may be performed. When the image is acquired in step S155, the processor 110 generates a plurality of print previews (step S200) by the functions of the multi-up layout acquisition section 112 and the preview display section 113, and transmits the print previews to the terminal device 400 to display the print previews (steps S205 and S210).

In step S200, a multi-up layout according to the number of selected images is acquired. The multi-up layout according to the number of images is, for example, a multi-up layout in which a margin is not generated. Here, the margin is a state in which the image is not assigned to any multi-up region of the multi-up layout. More specifically, for example, when the number of images is two, two patterns of 2-in-1 such as a and b illustrated in c3 in FIG. 6 are acquired as candidates, and a preview image in which the print target image is assigned to each of the two patterns is generated and displayed on the terminal device. For example, when the number of images is three, patterns of 3-in-1 such as c and d illustrated in c3 in FIG. 6 are acquired as candidates, and the three images are assigned to these two patterns to generate two types of print previews and display the print previews on the terminal device. In addition, for example, when the number of images is four, the patterns of 2-in-1 such as a and b illustrated in c3 in FIG. 6 and patterns of 4-in-1 such as e and f are acquired as candidates, and the four images are assigned to these four patterns to generate four types of print previews and display the print previews on the terminal device. For example, when the number of images is five, a combination of 2-in-1 and a 3-in-1 and the like are acquired as candidates, such as a combination of a and c and a combination of b and d. Alternatively, for example, a multi-up layout to be acquired as a candidate may be determined in advance for each number of images. More specifically, for example, when the number of images is two, two patterns of 2-in-1 such as a and b illustrated in c3 in FIG. 6 are acquired as candidates, and a preview image in which the print target image is assigned to each of the two patterns is generated and displayed on the terminal device. For example, when the number of images is three, the patterns of 2-in-1 such as a and b illustrated in c3 in FIG. 6 and the patterns of 3-in-1 such as c and d are acquired as candidates, and the three images are assigned to these four patterns to generate four types of print previews and display the print previews on the terminal device. When the three images are to be assigned to the multi-up layouts of 2-in-1 such as a and b, a preview image indicating that a first image is assigned to a first multi-up region of a first page, a second image is assigned to a second multi-up region of the first page, and a third image is assigned to a first multi-up region of a second page is generated.

When the user of the terminal device 400 selects any of the print previews displayed on the terminal device 400 and selects a printing instruction, the processor 110 acquires the printing instruction for a multi-up layout of the selected print preview from the terminal device 400 by the function of the multi-up layout acquisition section 112 (steps S215 and S220). In and After step S220, the same process as the process in and after step S180 in FIG. 3 may be performed. With the configuration, the user can check each print preview using the candidates for a multi-up layouts automatically acquired according to the number of images as print targets, and can select a multi-up layout from the candidates and execute printing.

The multi-up layout acquisition section may be configured to acquire the candidate for the multi-up layout further according to whether the selected image is a portrait shape or a landscape shape. That is, in step S200 in FIG. 12, the candidate for the multi-up layout is acquired according to whether the print target image is a portrait shape or a landscape shape, and the print preview in which the image is assigned for each candidate may be generated. The portrait image is an image in which the number of pixels in a vertical direction (height of the image) is larger than the number of pixels in a horizontal direction (width of the image), and the landscape image is an image in which the number of pixels in the horizontal direction is larger than the number of pixels in the vertical direction. It is determined in advance whether each multi-up region of each multi-up layout is a region to which the portrait image is assigned or a region to which the landscape image is assigned. Specifically, for example, it is determined that the landscape image is assigned to each of the first and second multi-up regions in the multi-up layout of a of c3 in FIG. 6, and the portrait image is assigned to each of the first and second multi-up regions of the multi-up layout of b.

For example, when the processor 110 acquires two images as print targets by the image acquisition section 111 and both of the two images are portrait, the multi-up layout of b illustrated in c3 in FIG. 6 is acquired as a candidate. In the multi-up layout of b, the two multi-up regions have the portrait shape. That is, the candidate a and b for the multi-up layout in which the two images are to be assigned are further narrowed down to b. For example, when the processor 110 acquires two images as print targets and both of the two images have the landscape shape, the multi-up layout of a illustrated in c3 in FIG. 6 is acquired as a candidate. In the multi-up layout of a, the two multi-up regions have the landscape shape.

For example, when a plurality of images acquired as print targets include a portrait image and a landscape image, the portrait image may be adopted with a multi-up layout having a portrait multi-up region, and the landscape image may be adopted with a multi-up layout having a landscape multi-up region to generate and display a preview image. Specifically, for example, when three images as print targets are acquired, one of the three images is a landscape image, and the other two images are portrait images, a preview image in which for the one landscape image, the one landscape image is arranged in one of the multi-up regions of the multi-up layout of a, which is illustrated in c3 in FIG. 6, and for the two landscape image, the two portrait images are arranged in two multi-up regions of the multi-up layout of b may be generated and displayed as one of the candidates. In addition to the preview image, the processor 110 may acquire, as a candidate, a multi-up layout in which a first multi-up region in the multi-up layout of a illustrated in c3 in FIG. 6 and third and fourth multi-up regions in the multi-up region of e are combined on one page, arrange one landscape image in one landscape multi-up region of the candidate, and generate and display a preview image in which two portrait images are respectively arranged in two portrait multi-up regions of the candidate. With the configuration, the user can check each print preview according to the candidate multi-up layout automatically acquired depending on the shape of the image as a print target, specifically, whether the image is a portrait shape or a landscape shape, and can select a multi-up layout from the print preview and execute printing.

In the above embodiment, an example is illustrated in which the order of multi-up of the plurality of images is an order according to the order in which the user selects the images, but the order of multi-up is not limited to this example. For example, a configuration may be adopted in which the order of the images to be arranged according to a multi-up layout is determined according to date information of the image selected from the list. The date information may be assumed to be, for example, a creation date and time of a screenshot image, an imaging date and time of an image by a camera, and the like. The order according to the date information includes, for example, an order of the oldest date or an order of the newest date. With such a configuration, the user can obtain a printed matter assigned in the order according to the date information.

The preview display section may be configured to change the order of the arrangement of the images in a multi-up layout in response to an arrangement change operation on the preview image displayed on the terminal device. For example, as illustrated in FIG. 11, when the print preview in which the images are respectively assigned to the two frames on the left and right is displayed on a printing medium of landscape A4, when an operation of swiping the image assigned to the right frame to the left frame is performed, the operation is regarded as an arrangement change operation of replacing the images assigned to the two frames on the left and right, the print preview is re-generated by replacing the images assigned to the frames on the left and right, and the preview image is transmitted to the terminal device and displayed. With such a configuration, the user can change the arrangement order of the images by performing the arrangement change operation when the user wants to change the arrangement order after checking the preview image.

In the above embodiment, the printing instruction transmission section is configured to print on the printing medium set in the print setting when the first menu is selected and printing on plain paper is not available, but the present disclosure is not limited to this. For example, when the first menu is selected, the printing instruction transmission section may be configured to determine whether or not printing on plain paper is available, and when printing on plain paper is not available, a message that printing on plain paper is not available, such as "printing on A4 plain paper is not supported" may be displayed on the terminal device. With such a configuration, the user of the terminal device can recognize that the image cannot be printed on plain paper.

Further, the printing instruction transmission section may be configured to display a printing medium selection section on the terminal device and select the printing medium when the first menu is selected and printing on plain paper is not available. Specifically, in the sequence illustrated in FIG. 3, when printing on A4 plain paper is not available after the process in step S185, the printing control apparatus 100 causes the terminal device 400 to display the printing medium selection section, and causes the user to select the printing medium to be used for printing. With such a configuration, for the first menu, when printing on plain paper is not available, the user of the terminal device can be prompted to change the setting to a printing medium other than plain paper. A configuration may be provided in which a printing medium on which the printing apparatus 200 can perform printing is acquired, and the printing medium selection section displays the printing medium on which the printing apparatus 200 can perform printing, as an option.

A configuration may be provided in which when the first menu is selected, the printing instruction transmission section displays the printing medium selection section on the terminal device 400, and when an operation of changing the printing medium is performed on the printing medium selection section, the printing instruction transmission section changes the setting of the printing medium from plain paper to the printing medium selected by the user, and transmits a printing instruction to execute printing on the changed printing medium. That is, a configuration may be provided in which even when the first menu is selected, the user can change the printing medium of plain paper, which is a default printing medium in the first menu, to another type of printing medium, regardless of whether or not the printing apparatus can print on plain paper. With the configuration, even when the first menu is selected, the user can give an instruction to print an image on a printing medium other than plain paper.

Further, a configuration may be provided in which when the second menu is selected, the printing instruction transmission section displays the printing medium selection section on the terminal device 400, and when an operation of changing the printing medium is performed on the printing medium selection section, the printing instruction transmission section changes the setting of the printing medium from photo paper to the printing medium selected by the user, and transmits a printing instruction to execute printing on the changed printing medium. That is, a configuration may be provided in which even when the second menu is selected, the user can change the printing medium of photo paper, which is a default printing medium in the second menu, to another type of printing medium, regardless of whether or not the printing apparatus can print on photo paper. With such a configuration, even when the second menu is selected, the user can give an instruction to print an image on a printing medium other than photo paper.

In the above embodiment, the first menu and the second menu are provided as print menus for printing an image, and the image is printed on plain paper when the first menu is selected. Meanwhile, a configuration may be provided in which whether or not the image selected as the print target is a screenshot image is determined, a printing instruction for printing the image on plain paper is transmitted to the printing apparatus when the image is the screenshot image, and a printing instruction for printing the image on photo paper is transmitted to the printing apparatus when the image is not the screenshot image. Various types of information related to the image is included in an image file. For example, when an image is captured by a camera, the image file includes a date and time of the image captured by the camera, a manufacturer name of the camera, a model name of the camera, and the like. The manufacturer name of the camera may be, for example, a manufacturer name of a smartphone when the camera is provided in the smartphone. In addition, the model name of the camera may be, for example, a model name of a smartphone when the camera is provided in the smartphone. When the image is a screenshot image of a screen instead of the image captured by the camera, tags of the date and time of the image captured by the camera, the manufacturer name of the camera, and the model name of the camera described above are not included in the image file. Alternatively, even though the tag is present in the image file, no valid value is described. Information indicating a generation date of the screenshot image may be included in the image file separately from the imaging date by the camera. By analyzing meta information of these images, whether or not the image is a screenshot image can be determined. In this manner, the image selected as the print target is analyzed to determine whether or not the selected image is a screenshot image. Therefore, the image determined to be a screenshot image can be printed on plain paper, and the image determined not to be a screenshot image can be printed on photo paper.

Further, the present disclosure can also be applied as a program executed by a computer, a printing control method, and a printing system. Further, the system, the program, or the method as described above may be achieved as a single device, may be achieved by using components provided by a plurality of devices, and includes various aspects. Further, a part of the system, the program, or the method can be changed as appropriate, and a part thereof is software and a part thereof is hardware. Further, the disclosure is also established as a recording medium for a program that controls a system. Of course, the recording medium of the program may be a magnetic recording medium or a semiconductor memory, and any recording medium developed in the future can be considered in exactly the same way.

What is claimed is:

1. A printing control apparatus comprising:
an image acquisition section that causes a terminal device to display a list of images stored in the terminal device and acquires an image selected as a print target from the list on the terminal device;
a multi-up layout acquisition section that causes the terminal device to display candidates for a plurality of multi-up layouts and acquires the multi-up layout selected from the candidates;
a preview display section that causes the terminal device to display a preview image in which the selected image is arranged according to the multi-up layout; and
a printing instruction transmission section that generates print data in which the selected image is arranged according to the multi-up layout and transmits a printing instruction for the print data to a printing apparatus, wherein
at least one of the image acquisition section, the multi-up layout acquisition section, and the preview display section is processed via a chat server.

2. The printing control apparatus according to claim 1, wherein
the process of the multi-up layout acquisition section is executed before the process of the image acquisition section.

3. The printing control apparatus according to claim 1, wherein
the process of the image acquisition section is executed before the process of the multi-up layout acquisition section.

4. The printing control apparatus according to claim 3, wherein
the multi-up layout acquisition section is configured to
acquire the candidate for the multi-up layout according to the number of selected images, and cause the preview display section to generate a preview image for the candidate and display preview images on the terminal device, and
acquire the multi-up layout adopted in a preview image selected by a user among the displayed preview images, and
the printing instruction transmission section generates the print data in which the selected image is arranged according to the acquired multi-up layout, and transmits the printing instruction for the print data to the printing apparatus.

5. The printing control apparatus according to claim 4, wherein
the multi-up layout acquisition section acquires the candidate for the multi-up layout further according to whether the selected image is a portrait image or a landscape image.

6. The printing control apparatus according to claim 1, wherein
an order of the image to be arranged according to the multi-up layout is determined in an order in which the image is selected from the list.

7. The printing control apparatus according to claim 1, wherein
an order of the image to be arranged according to the multi-up layout is determined according to date information of the image selected from the list.

8. The printing control apparatus according to claim 1, wherein
the preview display section changes an order of the arrangement of the image in the multi-up layout according to an arrangement change operation on the preview image displayed on the terminal device.

9. A printing control method in a printing control apparatus, the method comprising:
displaying, via an image acquisition section, a list of images stored in a terminal device on the terminal device and acquiring an image selected as a print target from the list on the terminal device;
displaying, via a multi-up layout acquisition section, candidates for a plurality of multi-up layouts on the terminal device and acquiring the multi-up layout selected from the candidates;
displaying, via a preview display section, a preview image in which the selected image is arranged according to the multi-up layout on the terminal device; and
generating, via a printing instruction transmission section, print data in which the selected image is arranged according to the multi-up layout and transmitting a printing instruction for the print data to a printing apparatus, wherein
at least one of the image acquisition section, the multi-up layout acquisition section, and the preview display section is processed via a chat server.

10. A printing system comprising:
a printing control apparatus; and
a printing apparatus,
the printing control apparatus configured to include
an image acquisition section that causes a terminal device to display a list of images stored in the terminal device and acquires an image selected as a print target from the list on the terminal device,
a multi-up layout acquisition section that causes the terminal device to display candidates for a plurality of multi-up layouts and acquires the multi-up layout selected from the candidates,
a preview display section that causes the terminal device to display a preview image in which the selected image is arranged according to the multi-up layout, and
a printing instruction transmission section that generates print data in which the selected image is arranged according to the multi-up layout and transmits a printing instruction for the print data to the printing apparatus, wherein
the printing apparatus executes printing based on the print data, and
at least one of the image acquisition section, the multi-up layout acquisition section, and the preview display section is processed via a chat server.
